(19) United States
(12) Patent Application Publication
(10) Pub. No.: US 2011/0109521 A1
(43) Pub. Date: May 12, 2011

(54) ELECTRONIC DEVICE COMPRISING A SEMICONDUCTOR COMPONENT INTEGRATING AN ANTENNA

(75) Inventors: Romain Pilard, Goncelin (FR); Daniel Gloria, Detrier (FR); Frederic Gianesello, Crolles (FR); Cedric Durand, Saint Martin D'heres (FR)

(73) Assignee: STMicroelectronics S.A., Montrouge (FR)

(21) Appl. No.: 12/941,292

(22) Filed: Nov. 8, 2010

(30) Foreign Application Priority Data
Nov. 10, 2009 (FR) 0957941

(51) Int. Cl. H01Q 1/48

(52) U.S. Cl. 343/848

(57) ABSTRACT

An electronic device includes a semiconductor component having a support substrate in the form of a wafer. On one side of this substrate integrated circuits including an RF circuit and an antenna connected to this RF circuit are formed. A metal layer is situated on the other side of the substrate, facing the antenna. At least on metal via is provided in a through-hole in the substrate, this via being connected at one end to the metal layer and at the other end to the RF circuit, at the same reference potential node as the antenna.

### PRIORITY CLAIM

This application claims priority from French Application for Patent No. 09-57941 filed Nov. 10, 2009, the disclosure of which is hereby incorporated by reference.

### TECHNICAL FIELD

The present invention relates to the field of semiconductor components and to electronic devices comprising such components.

### BACKGROUND

There exists a need to integrate electromagnetic antennas with semiconductor components and, at the same time, to improve the transmission/reception of radiofrequency signals, without at all increasing the footprint of such components.

### SUMMARY

An electronic device is proposed which may comprise a semiconductor component comprising a support substrate in the form of a wafer and, on one side of this substrate, integrated circuits comprising an RF circuit and an antenna connected to this RF circuit so as to transmit/receive radiofrequency signals.

Such an electronic device may furthermore comprise a metal layer situated on the other side of the substrate, facing said antenna, and at least one metal via provided in a through-hole in the substrate, this via being connected at one end to said metal layer and at the other end to the RF circuit, at the same reference potential node as said antenna.

Said metal layer may extend across a zone enclosing at least a main part of said antenna.

The electronic device may comprise a plurality of metal vias provided in through-holes in the support substrate and placed around a zone enclosing at least the main part of said antenna, these vias being connected at one end to said metal layer and at the other end to the RF circuit, at the same reference potential node as said antenna.

Said metal layer may be formed on the surface of the support substrate located on said other side of this support substrate.

Said metal layer may be formed on a surface of another component, located next to said other side of the substrate, and comprising electrical connection means interposed between said at least one via in the support substrate and the metal layer of said other component.

### BRIEF DESCRIPTION OF THE DRAWINGS

Electronic devices will now be described by way of non-limiting example, illustrated by the drawings in which:

FIG. 1 represents a schematic of an electronic device viewed from above;

FIG. 2 represents a cross section, approximately along the line II-II, of the electronic device of FIG. 1;

FIG. 3 represents a schematic of another electronic device viewed from above; and

FIG. 4 represents a cross section, approximately along the line IV-IV, of the electronic device of FIG. 3.

### DETAILED DESCRIPTION OF THE DRAWINGS

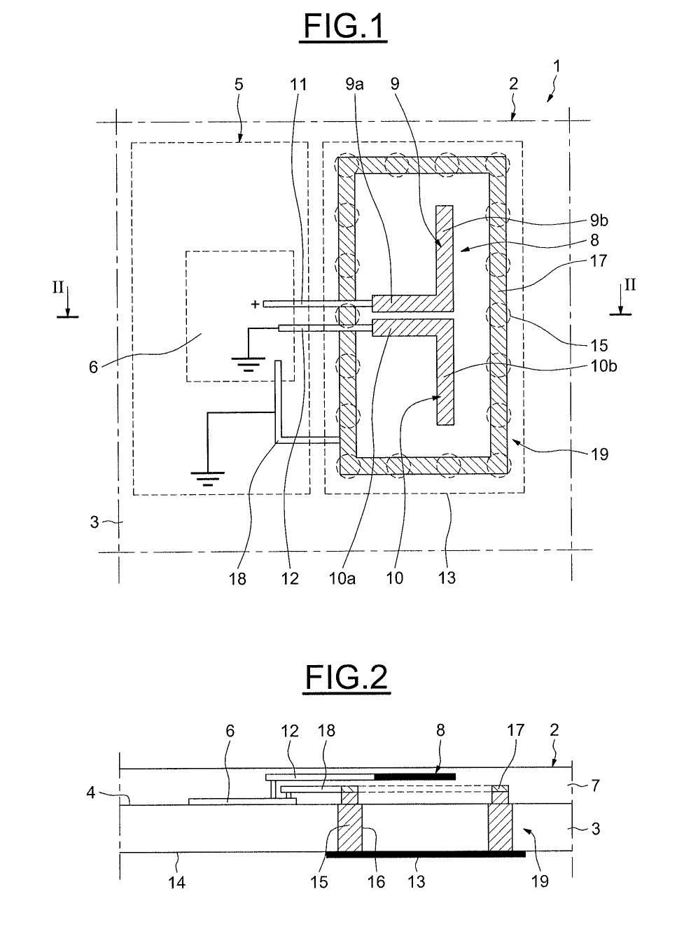

With reference to FIGS. 1 and 2, it is seen that an electronic device 1 may comprise a semiconductor component 2.

This semiconductor component 2 comprises a support substrate 3 in the form of a wafer, generally made of silicon, on a front side 4 of which integrated circuits 5 are produced comprising especially an RF circuit 6 and an interconnect layer 7. This layer 7 generally comprises various metallization levels separated by insulator sublayers; electrical connection vias through these sublayers allow the connection of the various metal tracks.

The semiconductor component 2 furthermore comprises a metal antenna 8 provided in and integrated into the interconnect layer 7, in a zone devoid of integrated circuits and at a higher metallization level.

In this example, the metal antenna 8 comprises two parts 9 and 10 having two strips 9a and 10a parallel and close to each other and two strips 9b and 10b aligned and extending in opposite directions from first corresponding ends of strips 9a and 10a.

The other ends of the strips 9a and 10a are connected to the RF circuit 6 by electrical connection tracks 11 and 12 and optionally by suitable electrical connection vias integrated into the interconnect layer 7.

In one embodiment, on being excited by the integrated RF circuit 6 when acting as a transmitter, the metal antenna 8 will transmit radiofrequency signals in the form of electromagnetic waves.

In another embodiment, when the RF circuit 6 is acting as receiver, the metal antenna 8 will pick up electromagnetic waves and deliver radiofrequency signals to the integrated RF circuit 6.

The semiconductor component 2 furthermore comprises a metal layer 13 formed on the other side or back side 14 of the support substrate 3, opposite to its front side 4.

This metal layer 13 extends, facing the metal antenna 8, across a zone enclosing at least a main part of this antenna, in particular all of the antenna.

For example, the metal layer 13 may be in the shape of a rectangle and have sides respectively parallel to the strips 9a and 10a and to strips 9b and 10b and at distance from the latter.

The semiconductor component 2 furthermore comprises a plurality of metal vias 15 provided or produced in holes 16 through the thickness of the support substrate 3.

The metal vias 15 may be placed at the periphery of the metal layer 13, so that the peripheral part of this metal layer 13 covers their ends located on the side 14 of the support substrate 3, thus producing an electrical connection.

For example, the metal vias 15 may be placed λ/4 from the arms 9b and 10b of the antenna 8 and regularly spaced along the periphery of the metal layer 13, the distance between them possibly being approximately equal to λ/10, λ being the working wavelength of the antenna.

The semiconductor component 2 furthermore comprises, integrated into a lower metallization level of the interconnect layer 7, a rectangular front interconnect 17 passing above the ends of the metal vias 15 located on the side 4 of the support substrate 3 and connected to the integrated RF circuit by a metal track 18 which is also integrated into the interconnect layer 7.

The RF circuit 6 may generate a reference potential at a node common to the metal antenna 8 and to the array 19 formed by the metal layer 13, the metal vias 15 and the metal track 18 which are electrically connected by the front interconnect 17, this array 19 forming an integrated cavity right through the support substrate.

In the zone or the volume delimited by this array 19, the semiconductor component 2 may have no other metal part except the metal antenna 8 and optionally to some extent the connection means of this antenna to the RF circuit 6.

The metal layer 13 forms a member that prevents the electromagnetic waves generated by the transmitting metal antenna 8 from escaping to the outside through and by way of the back of the support substrate 3 and that reflects these electromagnetic waves so that the electromagnetic radiation from the metal antenna 8 propagates to the outside by way of the front of the support substrate 3 on which the antenna is formed.

The metal vias 15 provided through the support substrate 3, optionally supplemented by the interconnect 17, contribute to the above effects and furthermore isolate the integrated circuits 5 from the electromagnetic radiation from the metal antenna 8 and the metal antenna 8 from the electromagnetic radiation from the integrated circuits 5.

The metal antenna 8, when acting as a receiver, is confined in the volume of the array 19 so as to be sensitive to electromagnetic waves appearing on the front side of the semiconductor component 2, without interference by electromagnetic radiation coming from the outside by way of the back or coming from the integrated circuits 5.

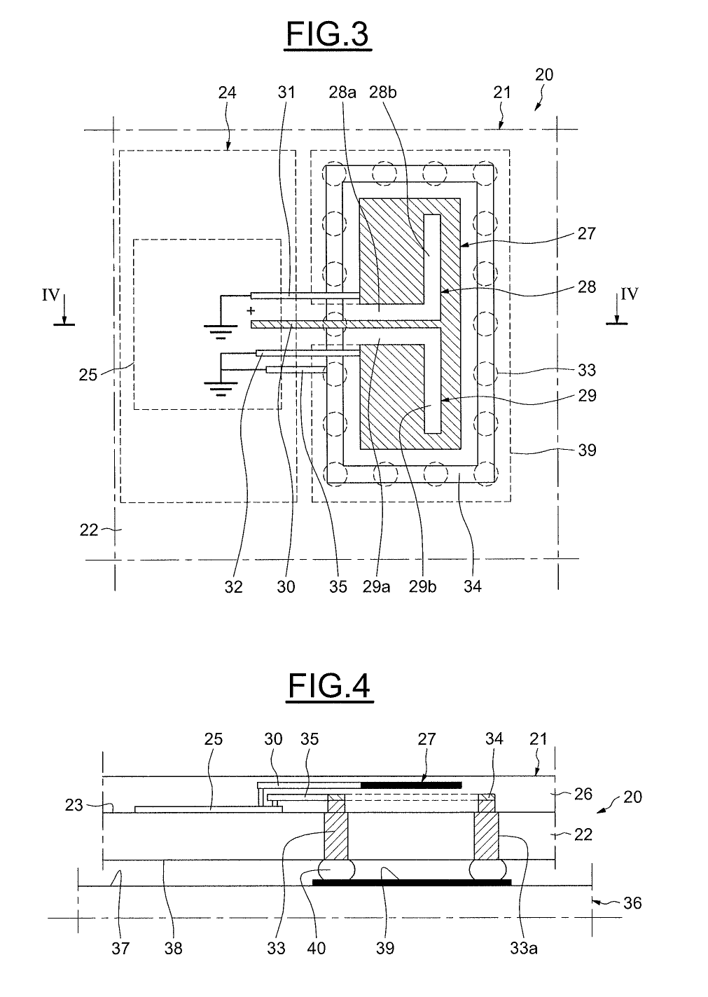

FIGS. 3 and 4 show another electronic device 20 which may comprise a semiconductor component 21.

As in the previous example, this semiconductor component 21 comprises a support substrate 22 in the form of a wafer, generally made of silicon, on a front side 23 of which integrated circuits 24 are produced comprising especially an RF circuit 25 and an interconnect layer 26 on this side 23.

The semiconductor component 21 furthermore comprises a metal antenna 27 integrated into an upper level of the interconnect layer 26, in a zone devoid of integrated circuits.

In this example, the metal antenna 27 comprises a rectangular metal layer 27 with two L-shaped cut-outs or voids 28 and 29 having two parallel arms 28a and 29a, close to each other, and two arms 28b and 29b extending in opposite directions from each other, the parallel arms 28a and 29a intersecting a long side of the rectangular metal layer 27.

The parallel arms 28a and 29a contain between them an electrical connection track 30 of the rectangular metal layer 27, being extended so as to be connected to the RF circuit 25.

On either side of the parallel arms 28a and 29a, electrical connection tracks 31 and 32 of the interconnect layer 26 connect the rectangular metal layer 27 to a reference potential of the RF circuit 25.

The metal antenna 27 may operate as the metal antenna 8 of the previous example.

The semiconductor component 21 furthermore comprises a plurality of metal vias 33 provided or produced in holes 33a through the thickness of the support substrate 22.

These metal vias 33 are placed outside and at distance from the rectangular zone covered by the antenna 27.

The semiconductor component 21 furthermore comprises, integrated into a lower metallization level of the interconnect layer 26, a rectangular interconnect 34 which passes above those ends of the metal vias 33 that are situated on the side 23 of the support substrate 22 and which is connected to the integrated RF circuit 25 by a metal track 35 also integrated into the interconnect layer 26.

The metal track 34 may be connected to the reference potential of the RF circuit 25 so that the vias 33 are connected to this reference potential.

The electronic device 20 may furthermore comprise another component 36 having a surface 37 adjacent to and distanced from the back side 38 of the substrate 22 opposite from its front side 23.

This other component 36, which may be another semiconductor component or a printed circuit board, has on its surface 37 a rectangular metal layer 39, the periphery of which envelops the metal vias 33.

Between the peripheral part of the metal layer 39 and the ends of the metal vias 33, on the side 38 of the support substrate 22, are interposed electrical connection balls 40, so that the metal layer 39 is connected to the reference potential of the RF circuit 25.

The metal layer 39 and the metal vias 33, as well as, optionally, the rectangular interconnect 34 and the electrical connection balls 40 may generate reflection, protection and confinement effects corresponding to those of the metal layer 13, the metal vias 15 and the interconnect 17 of the example described with reference to FIGS. 1 and 2.

The present invention is not limited to the examples given above. Many other examples are possible, particularly concerning the form of the antennas and the form of the electromagnetic wave reflection and electromagnetic protection means.

What is claimed is:

1. An electronic device, comprising:
a semiconductor component comprising: a support substrate in the form of a wafer;
integrated circuits on one side of the support substrate comprising an RF circuit and an antenna connected to the RF circuit;
a metal layer situated on the other side of the substrate, facing said antenna, and
at least one metal via provided in a through-hole in the substrate, this via being connected at one end to said metal layer and at the other end to the RF circuit at the same reference potential node as said antenna.

2. The device according to claim 1, wherein said metal layer extends across a zone enclosing at least a main part of said antenna.

3. The device according to claim 1, comprising a plurality of metal vias provided in through-holes in the support substrate and placed around a zone enclosing at least the main part of said antenna, these vias being connected at one end to said metal layer and at the other end to the RF circuit at the same reference potential node as said antenna.

4. The device according to claim 1, wherein said metal layer is formed on the surface of the support substrate located on said other side of this support substrate.

5. The device according to claim 1, in which said metal layer is formed on a surface of another component, located next to said other side of the substrate, and comprising electrical connection means interposed between said at least one via in the support substrate and the metal layer of said other component.

6. An electronic device, comprising:
a first substrate having a top surface and a bottom surface;
an integrated circuit formed in the first substrate;
interconnection layers on the top surface, the interconnection layers including a first layer with a metal antenna element and a second layer with an encircling metal track defining a center region, the metal antenna element positioned within the center region;
a plurality of vias passing through the first substrate, the vias positioned underneath and in contact with the encircling metal track.

7. The device of claim 6 wherein the metal antenna element comprises a first antenna segment and a second antenna segment, the first antenna segment and encircling metal track connected to a same reference potential node, and the second antenna segment connected to the integrated circuit.

8. The device of claim 7 wherein the first and second antenna segments have an “L” shape.

9. The device of claim 6 wherein the metal antenna element comprises a metal plate with an antenna opening formed therein, a first end of the metal plate and encircling metal track connected to a same reference potential node and a second end of the metal plate connected to the integrated circuit.

10. The device of claim 9, wherein the antenna opening has an “L” shape.

11. The device of claim 6, further comprising a metal layer mounted to the bottom surface of the first substrate under the center region.

12. The device of claim 6, further comprising a second substrate having a top surface including a metal conductor, the first substrate attached to the second substrate with the plurality of vias in electrical connection with the metal conductor on the top surface of the second substrate.

13. An electronic device, comprising:
a first semiconductor substrate;
an RF integrated circuit on a top side of the substrate;
an RF antenna connected to the RF circuit and formed in an interconnect level over the top side of the substrate;
a metal layer attached to a bottom side of the substrate in a position opposite said RF antenna, and
a set of metal vias arranged around the RF antenna, the vias electrically connected at one end to said metal layer and at the other end to the RF integrated circuit at the same reference potential node as said antenna.

14. The device of claim 13 further comprising a second substrate having a top surface, wherein the metal layer is mounted to the top surface of the second substrate, the first substrate attached to the second substrate with the plurality of vias in electrical connection with the metal conductor on the top surface of the second substrate.

15. The device of claim 13 further comprising an encircling metal track positioned over and in electrical contact with the set of metal vias.

16. The device of claim 15 wherein the RF antenna comprises a first antenna segment and a second antenna segment, the first antenna segment and encircling metal track connected to the same reference potential node, and the second antenna segment connected to the integrated circuit.

17. The device of claim 16 wherein the first and second antenna segments have an “L” shape.

18. The device of claim 15 wherein the metal antenna element comprises a metal plate with an antenna opening formed therein, a first end of the metal plate and encircling metal track connected to the same reference potential node and a second end of the metal plate connected to the integrated circuit.

19. The device of claim 18, wherein the antenna opening has an “L” shape.
